(19) United States
(12) Patent Application Publication
(10) Pub. No.: US 2024/0190033 A1
(43) Pub. Date: Jun. 13, 2024

(54) FLIP STOP

(71) Applicant: Hui-Chuan LIAO, Oakland, CA (US)

(72) Inventors: Hui-Chuan LIAO, Oakland, CA (US); Chun-Ti WANG, Taichung City (TW)

(21) Appl. No.: 18/079,867

(22) Filed: Dec. 12, 2022

(51) Int. Cl. B27B 27/10

(52) U.S. Cl. CPC B27B 27/10

(57) ABSTRACT

The flip stop has a body, a fixing component, and a flip arm. The body has a nut side, a track side opposite to the nut side, and an abutting portion disposed near the track side and tapering toward the track side. The fixing component has a bolt and a nut. The bolt is located through the body and has a bolt head located near the track side and allowing the flip stop to move along a T-track. The nut is threaded with the bolt to locate the body between the nut and the bolt head and is located near the nut side of the body. The flip arm is pivotally connected to the body. When the body and a T-track are fixed with respect to each other, the body is in line contact with the T-track, which leads to more stable and accurate positioning.

### BACKGROUND OF THE INVENTION

### 1. Field of the Invention

The present invention relates to a tool for woodworking, and particularly to a flip stop.

### 2. Description of Related Art

A flip stop is a tool for positioning a wood piece or a block of wood to measure the desired size into which the wood will be cut. The flip stop is commonly used with a fence and a T-track disposed on the fence.

With reference to FIG. 10, a conventional flip stop 90 has a body 91, a fixing component 92, and a flip arm 93. The body 91 has a fixing hole, and the fixing component 92 has a bolt 921 and a nut 922. The bolt 921 has a bolt head that is sized and shaped to be accommodated in an interior of a T-track 80, and the bolt 921 is located through the fixing hole of the body 91, which allows the body 91 to be disposed on the T-track 80 and movable along the T-track 80. Also, a tape measure is commonly disposed on the T-track 80 for moving the conventional flip stop 90 along the T-track 80 to a precise position according to a desired size for the cut wood. The nut 922 is configured to be threaded with the bolt 921. By turning the nut 922, the nut 922 and the bolt head of the bolt 921 approach each other to clamp the body 91 and the T-track 80 and make the body 91 and the T-track 80 fixed with respect to each other, so that the conventional flip stop 90 does not move away from the precise position. The flip arm 93 is pivotally connected to the body 91 and is capable of pivoting relative to the body 91 and being attached to a fence where the T-track 80 is disposed. The flip arm is for a wood piece or a block of wood to abut and be positioned.

With reference to FIG. 10, in the conventional flip stop 90, the body 91 has a fixing protrusion 911 having a width designed equal to a width of an opening 81 of the T-track 80 to make the body 91 and the T-track 80 fixed with each other more stably without relative movement. However, gaps still exist between edges of the opening 81 of the T-track 80 and the fixing protrusion 911 due to the manufacturing tolerance, and the body 91 is in surface contact with the T-track 80. When the fixing component 92 is tightened, the body 91 and the T-track 80 may still have relative movement, which leads to inaccuracy and error when positioning wood by the conventional flip stop 90.

To overcome the shortcomings of the conventional flip stop, the present invention tends to provide a flip stop to mitigate or obviate the aforementioned problems.

### SUMMARY OF THE INVENTION

The main objective of the present invention is to provide a flip stop that has a body configured to be in line contact with edges of an opening of a T-track to make the body and the T-track fixed with respect to each other more stably.

The flip stop has a body, a fixing component, and a flip arm. The body has two opposite sides respectively being a nut side and a track side and an abutting portion disposed near the track side and tapering toward the track side. The fixing component has a bolt and a nut. The bolt is located through the body and has a bolt head located near the track side of the body and configured to allow the flip stop to move along a T-track. The nut is configured to be threaded with the bolt to locate the body between the nut and the bolt head and is located near the nut side of the body. The flip arm is pivotally connected to the body. Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a flip stop of a first preferred embodiment in accordance with the present invention;

FIG. 2 is another operational perspective view of the flip stop in FIG. 1;

FIG. 3 is an exploded view of the flip stop in FIG. 1;

FIG. 4 is a side view of a body of the flip stop in FIG. 1;

FIG. 5 is an enlarged operational side view of the flip stop in FIG. 1;

FIG. 6 is an operational side view of the flip stop in FIG. 1, illustrating a motion of a flip arm of the flip stop;

FIG. 7 is another operational perspective view of the flip stop in FIG. 1;

FIG. 8 is a side view of the body of the flip stop of a second preferred embodiment in accordance with the present invention;

FIG. 9 is a side view of the body of the flip stop of a third preferred embodiment in accordance with the present invention; and

FIG. 10 is an enlarged operational side view of a flip stop in accordance with the prior art.

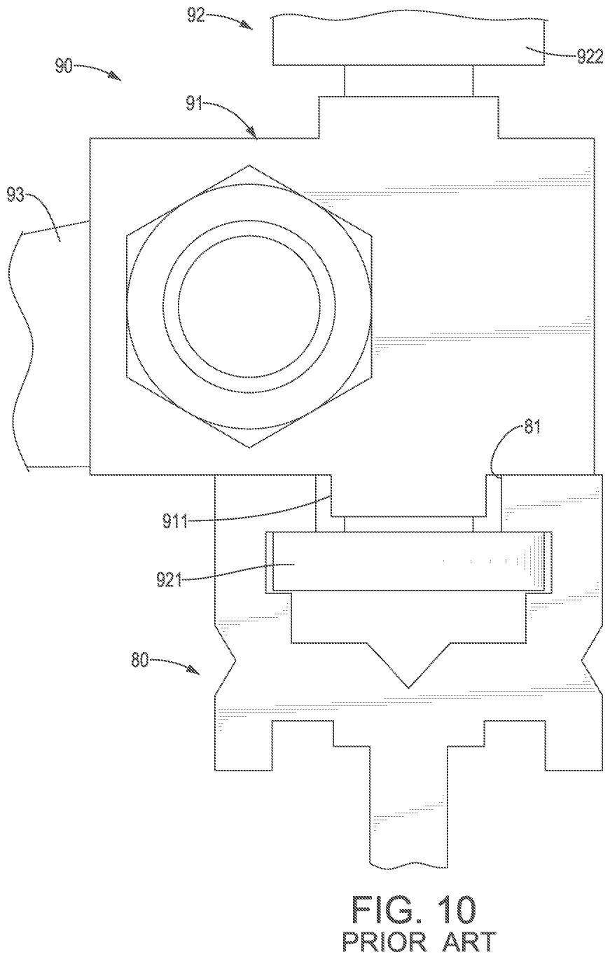

### DETAILED DESCRIPTION OF THE PREFERRED EMBODIMENT

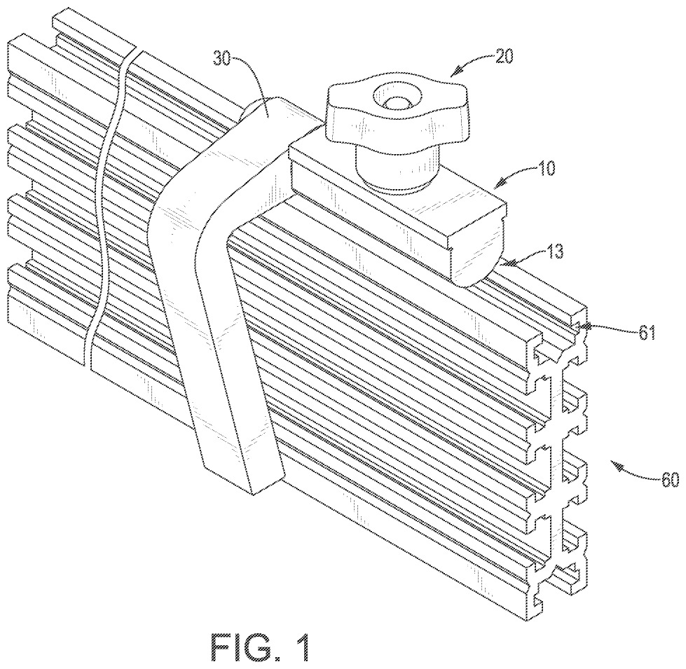

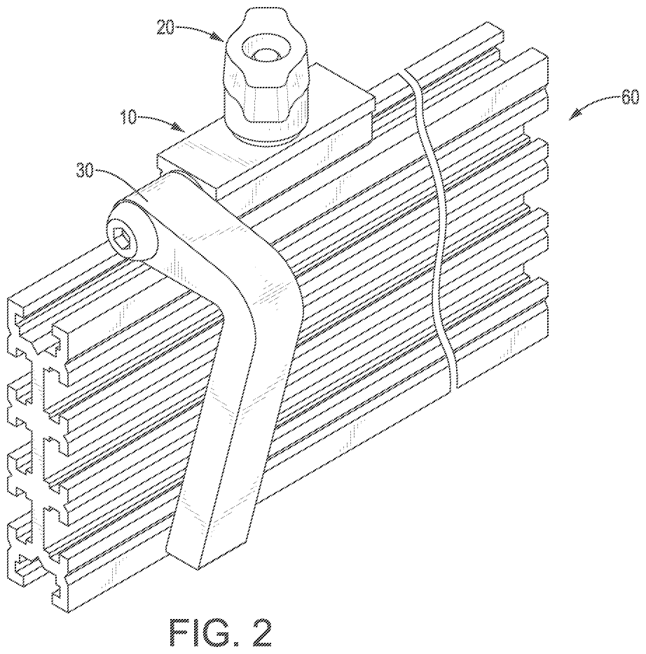

With reference to FIGS. 1 and 2, the flip stop of a first preferred embodiment in accordance with the present invention has a body 10, a fixing component 20, and a flip arm 30.

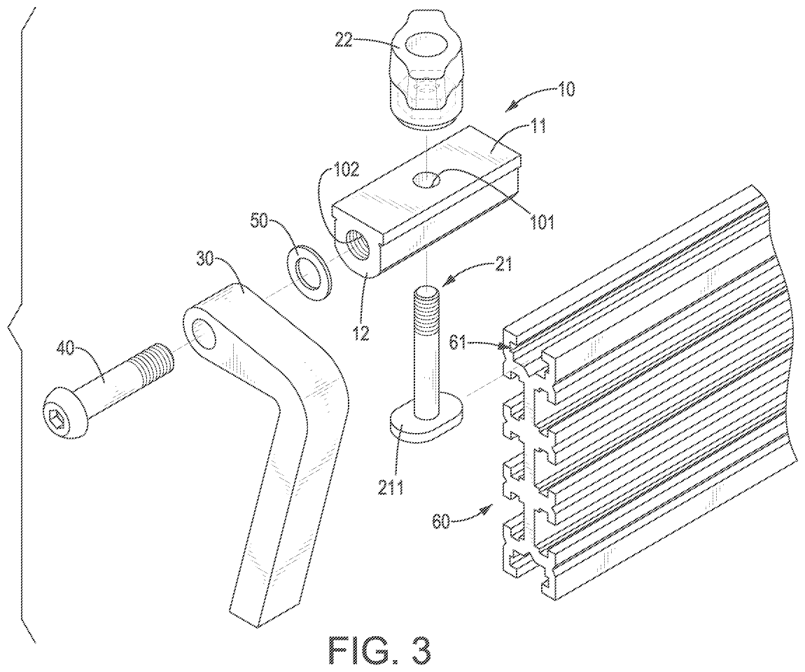

With reference to FIG. 3, the body 10 is elongated and has a fixing hole 101, a combining hole 102, and two opposite sides, and the two opposite sides of the body 10 are respectively a nut side 11 and a track side 12. The fixing hole 101 extends from the nut side 11 of the body 10 to the track side 12 of the body 10. The combining hole 102 extends from a side surface connecting the nut side 11 and the track side 12 to an interior of the body 10 and is a screw hole. The fixing hole 101 has an extending direction, and the combining hole 102 has an extending direction being perpendicular to the extending direction of the fixing hole 101.

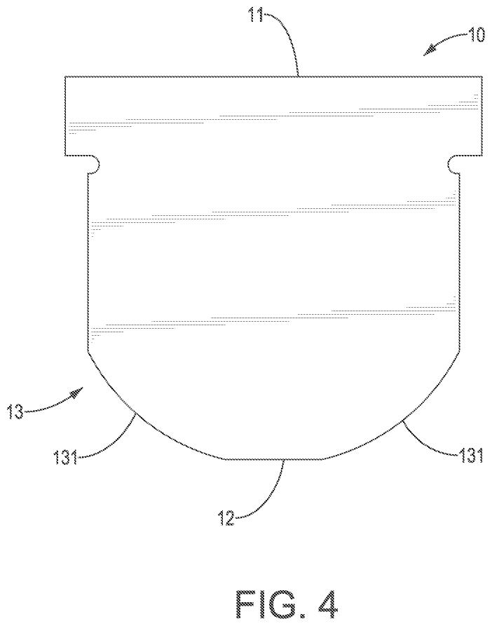

With reference to FIGS. 1 and 4, the body 10 has an abutting portion 13. The abutting portion 13 is disposed near the track side 12 of the body 10 and tapers from the nut side 11 toward the track side 12 of the body 10; specifically, a width of the abutting portion 13 tapers from the nut side 11 toward the track side 12. The abutting portion 13 has two abutting surfaces 131, and the two abutting surfaces 131 are disposed symmetrically. In the first preferred embodiment, each one of the two abutting surfaces 131 is a convex arc surface.

With reference to FIG. 3, the fixing component 20 has a bolt 21 and a nut 22. The bolt 21 is located through the body 10, and specifically, the bolt 21 is located through the fixing hole 101 of the body 10. The bolt 21 has a bolt head 211, and the bolt head 211 is sized and shaped to be accommodated in an interior of a T-track to allow the body 10 to move along the T-track. With reference to FIGS. 1 to 3, multiple T-tracks 61 are directly formed on a fence 60 made by aluminum extrusion, and the bolt head 211 of the bolt 21 is accommodated in an interior of one of the multiple T-tracks 61. In other operating circumstances, the T-track and the fence may be two individual components, and the T-track is mounted on the fence to have a same effect as the T-track directly formed on the fence.

The nut 22 is configured to be threaded with the bolt 21 to locate the body 10 between the nut 22 and the bolt head 211 of the bolt 21. The nut 22 is located near the nut side 11 of the body 10, and the bolt head 211 of the bolt 21 is located near the track side 12 of the body 10. The nut 22 is configured to be turned to approach the bolt head 211 of the bolt 21, and thus the nut 22 and the bolt head 211 clamp the T-track 61 and the body 10 and make the body 10 and the T-track 61 fixed with respect to each other. In the first preferred embodiment, the nut 22 is a knob screw for the convenience of operation.

The flip arm 30 is pivotally connected to the body 10, and an extending direction of a pivot between the flip arm 30 and the body 10 is perpendicular to a direction of the bolt 21 located through the body 10. Specifically, with reference to FIG. 3, the flip arm 30 has a pivot hole, and the flip stop has a pivot element 40 being a bolt. The pivot element 40 is located through the pivot hole of the flip arm 30 and is threaded into the combining hole 102 of the body 10, which allows the flip arm 30 to be pivotally connected to the body and pivot relative to the body 10.

Besides, with reference to FIG. 3, in the first preferred embodiment, the flip stop further has a washer 50. The pivot element 40 is sequentially located through the pivot hole of the flip arm 30 and a through hole of the washer 50 and is threaded into the combining hole 102 of the body 10. Two opposite sides of the washer 50 respectively abut the flip arm 30 and the body 10. The washer 50 thus helps reduce abrasion between the flip arm 30 and the body 10.

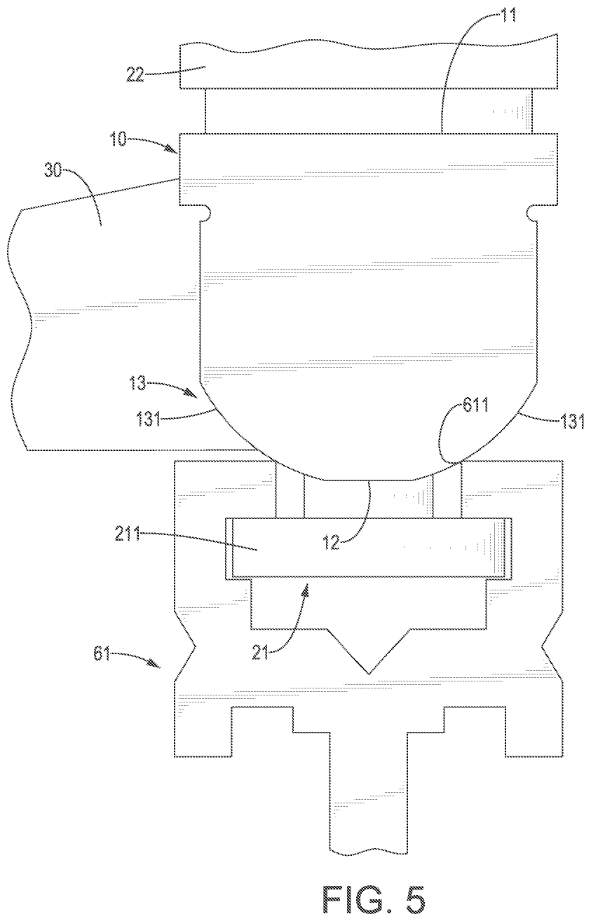

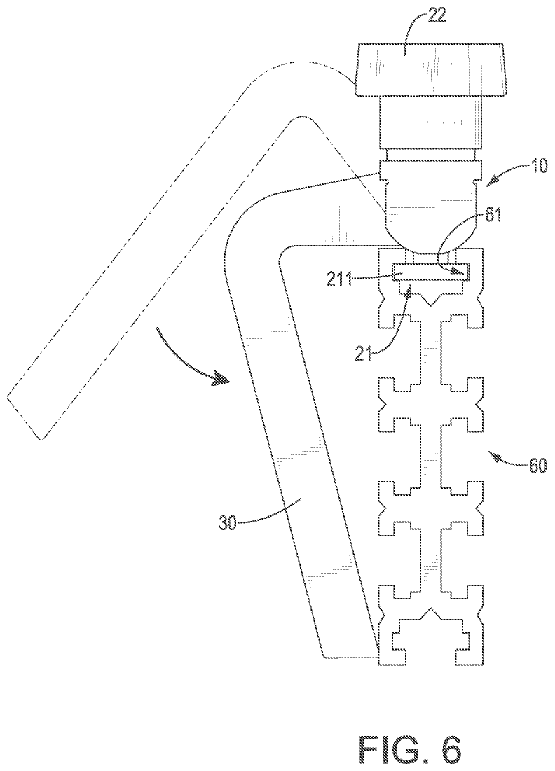

In use, with reference of FIGS. 5 and 6, the bolt head 211 of the bolt 21 located through the body 10 is first accommodated in the interior of the T-track 61 to allow the body 10 to move along the T-track 61. In FIGS. 5 and 6, the T-track 61 is a portion of a fence 60 made by aluminum extrusion. Generally, a tape measure is disposed on the T-track 61 or the fence 60, and the flip stop has an aligning construction to be aligned with a graduation on the tape measure. The aligning construction is specifically a needle pointer or a thin notch. The above configuration is conventional in the field of woodworking and is thus neither described in detail here nor shown in the figures.

Then, according to a desired size of the cut wood, the body 10 moves along the T-track to a setting position by aligning the aligning construction with a graduation on the tape measure according to the desired size. Afterwards, the nut 22 is turned to approach the bolt head 211 of the bolt 21, and the nut 22 and the bolt head 211 clamp the body 10 and the T-track 61 together to make the body 10 and the T-track 61 fixed with respect to each other. Thereby, the body 10 cannot move away from the corresponding position, and thereby the fixed body 10 can facilitate subsequent tasks of positioning.

With reference to FIG. 5, when the nut 22 is turned to make the body 10 and the T-track 61 fixed with respect to each other, the body 10 abuts the T-track 61 with the abutting portion 13, and more particularly, the two abutting surfaces 131 of the abutting portion 13 respectively abut two opposite edges of an opening 611 of the T-track 61. Since the abutting portion 13 tapers toward the track side 12 of the body 10, the two abutting surfaces 131 are in line contact with the two opposite edges of the opening 611 of the T-track 61.

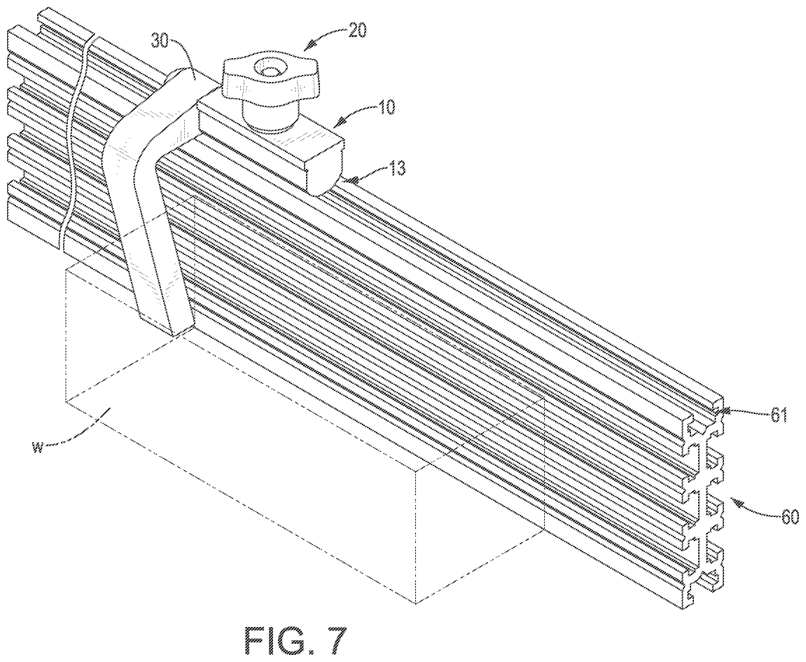

With reference to FIG. 6, the flip arm 30 is then actuated and pivots relative to the body 10 to be attached to the fence 60, and the preliminary task of positioning the wood to be cut is finished. Then, wood W ready for cutting is first attached to the fence 60 and then is moved along the fence 60 to abut the flip arm 30. With reference to FIG. 7, the wood W is thus positioned precisely in location. Finally, push the wood W with the fence 60 toward a saw blade for cutting. The wood W is cut into a wood piece of the desired size.

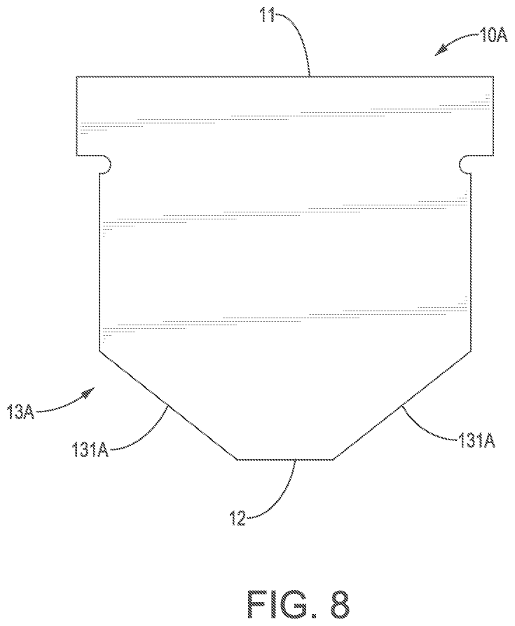

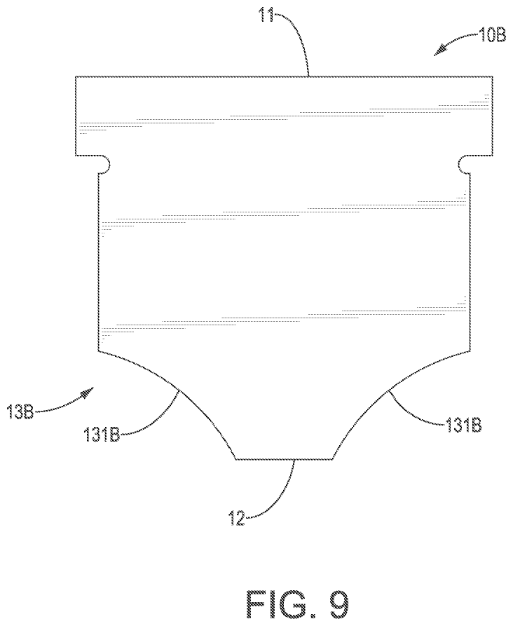

The flip stops of a second preferred embodiment and a third preferred embodiment in accordance with the present invention are almost the same as the flip stop of the first preferred embodiment. The difference is described below. With reference to FIG. 4, each one of the two abutting surfaces 131 of the abutting portion 13 of the body 10 is a convex arc surface in the first preferred embodiment. With reference to FIG. 8, in the second preferred embodiment, each one of the two abutting surfaces 131A of the abutting portion 13A of the body 10A is an inclined surface which are inclined relative to a central surface of the body 10A. With reference to FIG. 9, in the third preferred embodiment, each one of the two abutting surfaces 131B of the abutting portion 13B of the body 10B is a concave arc surface.

In the conventional flip stop 90, the width of the fixing protrusion 911 of the body 91 is designed equal to the width of the opening 81 of the T-track 80 for the body 91 and the T-track 80 to be fixed with each other more stably without relative movement, but the gaps still exist between edges of the opening 81 of the T-track 80 and the fixing protrusion 911 due to the manufacturing tolerance. The body 91 and the T-track 80 may still have relative movement, which leads to inaccuracy and error when positioning wood by the conventional flip stop 90. In comparison, in the flip stop of the present invention, the abutting portion 13, 13A, 13B tapers toward the track side 12 of the body 10, 10A, 10B. When the body 10, 10A, 10B and a T-track are fixed with respect to each other, the abutting portion 13, 13A, 13B is in line contact with edges of an opening of the T-track. Thereby, the body 10, 10A, 10B and the T-track are less likely to have relative movement. The flip stop of the present invention thus has more stable and accurate positioning effects.

In the three preferred embodiments above, the abutting portion 13, 13A, 13B of the body 10, 10A, 10B has the two abutting surfaces 131, 131A, 131B being symmetric and in line contact with the two opposite edges of the opening 611 of the T-track 61. In other embodiments, if the body 10 has the abutting portion 13 tapering toward the track side 12 of the body 10, the body 10 is in line contact with the T-track when fixed with the T-track, which allows the flip stop of the present invention to have more stable and accurate effect of positioning compared to the conventional flip stop. Another advantage of the three preferred embodiments above is that the flip stop can be used with different T-tracks having openings of different widths; when the body 10 and the T-track are fixed with respect to each other, two symmetrical positions respectively on the two abutting surfaces 131, 131A, 131B are respectively in line contact with and abut two opposite edges of the opening of the T-track. Thereby, a single flip stop of any one of the three preferred embodiments above is applicable with T-tracks of different brands or sizes, which greatly improves the convenience in use of the flip stop.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A flip stop comprising:
a body having
two opposite sides respectively being a nut side and a track side; and
an abutting portion disposed near the track side and tapering toward the track side;
a fixing component having
a bolt located through the body and having a bolt head which is located near the track side of the body and is configured to allow the flip stop to move along a T-track; and
a nut configured to be threaded with the bolt to locate the body between the nut and the bolt head of the bolt, the nut located near the nut side of the body; and
a flip arm pivotally connected to the body.

2. The flip stop as claimed in claim 1, wherein the abutting portion of the body has two abutting surfaces disposed symmetrically.

3. The flip stop as claimed in claim 2, wherein each one of the two abutting surfaces is one of an inclined surface, a concave arc surface, and a convex arc surface.

4. The flip stop as claimed in claim 1, wherein
the body has a combining hole;
the flip arm has a pivot hole; and
the flip stop has a pivot element located through the pivot hole and combined with the combining hole of the body.

5. The flip stop as claimed in claim 2, wherein
the body has a combining hole;
the flip arm has a pivot hole; and
the flip stop has a pivot element located through the pivot hole and combined with the combining hole of the body.

6. The flip stop as claimed in claim 3, wherein
the body has a combining hole;
the flip arm has a pivot hole; and
the flip stop has a pivot element located through the pivot hole and combined with the combining hole of the body.

7. The flip stop as claimed in claim 4, wherein
the flip stop has a washer;
the pivot element is located through the pivot hole of the flip arm and a through hole of the washer and combined with the combining hole of the body; and
two opposite sides of the washer respectively abut the body and the flip arm.

8. The flip stop as claimed in claim 5, wherein
the flip stop has a washer;
the pivot element is located through the pivot hole of the flip arm and a through hole of the washer and combined with the combining hole of the body; and
two opposite sides of the washer respectively abut the body and the flip arm.

9. The flip stop as claimed in claim 6, wherein
the flip stop has a washer;
the pivot element is located through the pivot hole of the flip arm and a through hole of the washer and combined with the combining hole of the body; and
two opposite sides of the washer respectively abut the body and the flip arm.
